(19) United States
(12) Patent Application Publication
(10) Pub. No.: US 2005/0088092 A1
(43) Pub. Date: Apr. 28, 2005

(54) Plasma display apparatus

(76) Inventors: Myoung-Kon Kim, Suwon-si (KR); Hyouk Kim, Suwon-si (KR); Sung-Won Bae, Suwon-si (KR); Joong-Ha Ahn, Suwon-si (KR)

Correspondence Address: Robert E. Bushnell;Suite 300, 1522 K Street, N.W., Washington, DC, 20005, US

(21) Appl. No.: 10/963,611

(22) Filed: Oct. 14, 2004

(30) Foreign Application Priority Data
Oct. 23, 2003 (KR) 10-2003-0072476
Mar. 4, 2004 (KR) 10-2004-0014564

(51) Int. Cl. H01J 17/49; H01J 61/52; H01J 7/24

(52) U.S. Cl. 313/582; 313/46; 313/33; 313/44

(57) ABSTRACT

A plasma display apparatus includes: a plasma display panel; a chassis base arranged parallel to the plasma display panel; a driver IC electrically connecting electrodes of the plasma display panel to a driving circuit, the driver IC adapted to supply voltage signals to the electrodes of the plasma display panel in accordance with signals from the driving circuit; and a heat dissipating plate arranged adjacent to the driver IC and facing the chassis base to interpose the driver IC between the chassis base and a heat dissipating plate; wherein the heat dissipating plate includes an accommodating portion adapted to accommodate the driver IC on a side surface thereof opposite to the driver IC.

### CLAIM OF PRIORITY

This application makes reference to, incorporates the same herein, and claims all benefits accruing under 35 U.S.C. §119 from applications entitled PLASMA DISPLAY APPARATUS filed earlier with the Korean Intellectual Property Office on 23 Oct. 2003 and 4 Mar. 2004 and there duly assigned Serial Nos. 2003-74276 and 2004-14564, respectively.

### BACKGROUND OF THE INVENTION

1. Field of the Invention

The present invention relates to a plasma display apparatus, and, more particularly, to a plasma display apparatus that includes a heat dissipating plate to efficiently transfer heat produced by a driver IC.

2. Description of the Related Art

Generally, a plasma display apparatus has a plasma display panel for displaying the desired images with a plasma generated by a gas discharge. The plasma display panel has electrodes that are electrically connected to a driving circuit, and a driver IC supplies voltage signals to the electrodes in accordance with signals outputted by the driving circuit.

Voltage application structures using a driver IC include a Chip-On-Board (COB) structure where the driver IC is mounted on a Printed Circuit Board (PCB), and a Chip-On-Film (COF) structure where the driver IC is directly mounted on a Flexible Printed Circuit (FPC) film. A small-sized and low cost Tape Carrier Package (TCP) is now being extensively used as a voltage application structure.

In order to express at least a 256 gray scale with a plasma display panel, at least eight-timed address discharges must occur during 1/60 of a second corresponding to one TV field, and hence, a considerable amount of heat is generated by the COF, the COB, or the TCP mounted on the chassis base.

Accordingly, a reinforcing plate is provided with the COB or the COF to reinforce its structural intensity integrity and fix it to the chassis base. The reinforcing plate further has a role of a heat sink to dissipate the heat generated by the IC to the outside.

A heat sink is used in order to dissipate the heat produced by the TCP driver IC. The heat sink that is used can be a solid heat dissipating sheet attached to the TCP to dissipate the heat into the air. However, such a heat sink has the low heat dissipation efficiency. Therefore, there is a problem in that the heat sink must be large relative to the size of the driver IC to dissipate the large amount of heat generated by the TCP driver IC.

### SUMMARY OF THE INVENTION

It is an object of the present invention to provide a plasma display apparatus which has a heat dissipating structure for a driver IC that is capable of enhancing the reliability of the driver IC in that it efficiently dissipates the heat produced by the driver IC to prevent a breakdown or other malfunction from occurring.

A plasma display apparatus according to one aspect of the present invention comprises: a plasma display panel; a chassis base arranged parallel to the plasma display panel; a driver IC electrically connecting electrodes of the plasma display panel to a driving circuit, the driver IC adapted to supply voltage signals to the electrodes of the plasma display panel in accordance with signals from the driving circuit; and a heat dissipating plate arranged adjacent to the driver IC and facing the chassis base to interpose the driver IC between the chassis base and a heat dissipating plate; wherein the heat dissipating plate includes an accommodating portion adapted to accommodate the driver IC on a side surface thereof opposite to the driver IC.

The accommodating portion preferably comprises a thermal conduction medium.

A thermal conduction medium is preferably interposed between the driver IC and a side surface of the heat dissipating plate opposite thereto.

The thermal conduction medium is preferably interposed between the accommodating portion of the heat dissipating plate and a side surface of the driver IC opposite thereto.

The accommodating portion of the thermal conduction medium is preferably filled with a thermally conductive liquid or gel medium.

The thermal conduction medium is preferably a silicone oil or a thermal grease.

The accommodating portion preferably includes an accommodating recess concavely formed on a side surface of the heat dissipating plate.

The accommodating portion preferably includes a projecting portion formed on another side surface thereof and corresponding to the accommodating recess.

A plurality of heat dissipating fins are preferably arranged integrally on another side surface of the heat dissipating plate.

A heat sink is preferably mounted on another side surface of the heat dissipating plate, the heat sink having a plurality of heat dissipating fins.

The heat dissipating plate preferably comprises: a first portion arranged in parallel with the chassis base so as to be opposed to the driver IC; and a second portion extending integrally from one distal end of the first portion toward a peripheral edge of the plasma display panel.

The driver IC is preferably electrically connected to electrodes of the plasma display panel via a Flexible Printed Circuit (FPC) and is wholly surrounded by the accommodating portion and wherein the accommodating portion is penetrated by the FPC passing therethrough.

The driver IC is preferably packaged in a Tape Carrier Package (TCP).

A plasma display apparatus according to another aspect of the present invention comprises: a plasma display panel; a chassis base having the plasma display panel on one side surface thereof and having a driving circuit arranged on another side surface thereof; a driver IC electrically connecting electrodes of the plasma display panel to the driving circuit, the driver IC adapted to supply voltage signals to the electrodes of the plasma display panel in accordance with signals from the driving circuit; a heat dissipating plate arranged adjacent to the driver IC and facing the chassis base to interpose the driver IC between the chassis base and the heat dissipating plate; and a first thermal conduction medium arranged between the heat dissipating plate and the driver IC and adapted to transfer heat generated by the driver IC to the heat dissipating plate.

The first thermal conduction medium is preferably a thermally conductive liquid or gel medium.

The first thermal conduction medium is preferably silicone oil or a thermal grease.

The first thermal conduction medium preferably has a coefficient of thermal conductivity of not less than 1.0 W/mK and a viscosity of not less than 100,000 cps.

A high thermally conductive solid member is preferably arranged on a portion of the chassis base opposite the driver IC.

The plasma display apparatus further preferably comprises a second thermal 11 conduction medium disposed between the solid member and the driver IC and adapted to transfer heat generated by the driver IC to the high thermally conductive solid member.

The second thermal conduction medium is preferably a thermally conductive liquid or gel medium.

The plasma display apparatus further preferably comprises a third thermal conduction medium arranged between the first thermal conduction medium and the driver IC.

The second thermal conduction medium is preferably a thermally conductive sheet.

The heat dissipating plate further preferably comprises an accommodating portion adapted to accommodate the first thermal conduction medium on a side surface thereof opposite the driver IC.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display apparatus having a heat dissipating structure for a driver IC according to a first embodiment of the present invention;

FIG. 2 is a cross-sectional view taken along the A-A line of FIG. 1;

FIG. 3 is a cross-sectional view of a heat dissipating structure for a driver IC according to the second embodiment of the present invention;

FIG. 4 is a cross-sectional view of a heat dissipating structure for a driver IC according to the third embodiment of the present invention;

FIG. 5 is a cross-sectional view of a heat dissipating structure for a driver IC according to the forth embodiment of the present invention;

FIG. 6 is a cross-sectional view of a heat dissipating structure for a driver IC according to the fifth embodiment of the present invention;

FIG. 7 is a cross-sectional view of a heat dissipating structure for a driver IC according to the sixth embodiment of the present invention;

FIG. 8 is a cross-sectional view of a heat dissipating structure for a driver IC according to the seventh embodiment of the present invention;

FIG. 9 is a cross-sectional view of a heat dissipating structure for a driver IC according to the eighth embodiment of the present invention;

FIG. 10 is a cross-sectional view of a heat dissipating structure for a driver IC according to the ninth embodiment of the present invention.

### DETAILED DESCRIPTION OF THE INVENTION

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

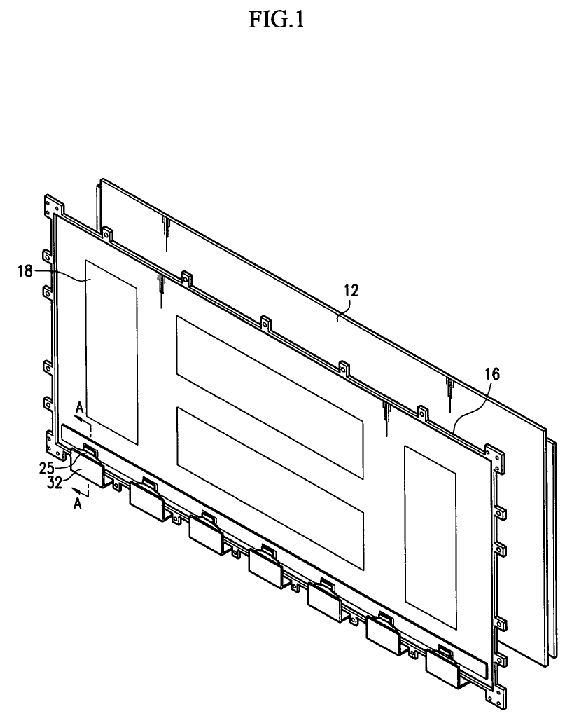

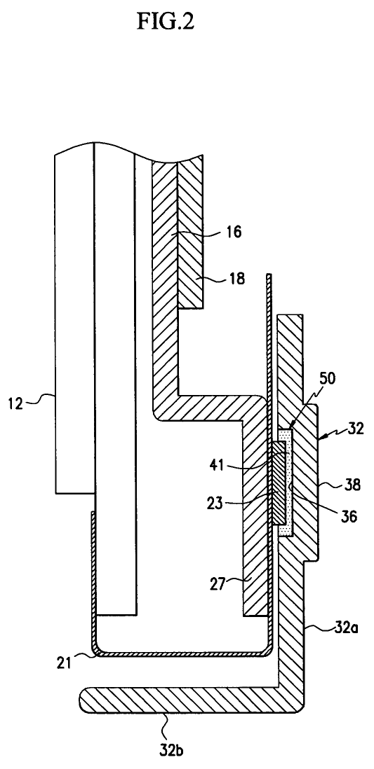

FIG. 1 is an exploded perspective view of a plasma display apparatus having a heat dissipating structure for a driver IC according to a first embodiment of the present invention, and FIG. 2 is a cross-sectional view taken along the A-A line of FIG. 1.

With reference to FIG. 1 and FIG. 2, the plasma display apparatus includes a plasma display panel 12 (referred to hereinafter simply as a “PDP”), and a chassis base 16. The chassis base 16 is made of Cu, Fe, or the like, and the PDP 12 is mounted on one side surface thereof and a driving circuit 18 is mounted on the other side surface of the chassis base 16.

The PDP 12 of the plasma display device is mounted on a chassis base (not shown), with a front cover (not shown) on the outside of the PDP 12 and a rear cover (not shown) on the outside of a chassis base.

Electrodes extending from the periphery of the PDP 12 are electrically connected to the driving circuit 18 to receive the signals required for driving the PDP 12.

A driver IC 23 is disposed between the PDP 12 and the driving circuit 18 to supply voltage signals to the electrodes in accordance with signals from the driving circuit.

The driver IC 23 is packaged in the form of a TCP 25 so that it electrically interconnects an FPC 21 and the driving circuit 18, and a the driver IC 23 is mounted over the TCP tape FPC 21. The driver IC 23 is arranged opposite to the chassis base 16.

On the outside of the driver IC 23, that is, the outside of the TCP 25, a heat dissipating plate 32 is arranged to support the TCP 25 and to fix it to the chassis base 16. The heat dissipating plate 32 is positioned in parallel with and along the periphery of the chassis base 16.

The heat dissipating plate 32 can be positioned in an integral plate longitudinally along the periphery of the chassis base 16, and a plurality of the heat dissipating plates 32 can be positioned successively along the periphery of the chassis base 16, wherein each of the heat dissipating plates 32 respectively corresponds to the driver IC 23.

The heat dissipating plate 32 can be provided with a first portion 32a opposite to the driver IC 23 and a second portion 32b extending integrally from one distal end of the first portion toward the peripheral edge of the PDP 12. Such a heat dissipating plate 32 can be made of Al, Cu, Fe, or the like in the same manner as the chassis base 16.

The heat dissipating plate 32 can be affixed to an extension portion 27 of the chassis base 16 by means of a fastening member (not shown), for example, a screw, or it can be affixed to a high thermally conductive solid member 127 as discussed below. A thermal conduction medium 41 is disposed between the first portion 32a of the heat dissipating plate 32 and the driver IC 23 so that it efficiently transfers the heat generated by the driver IC 23 to the heat dissipating plate 32.

In the plasma display apparatus according to the first embodiment of the present invention, the heat dissipating plate 32 is provided with an accommodating portion 50 for accommodating the driver IC 23 so that the thermal conductive medium 41 can be interposed between the driver IC 23 and one side surface of the heat dissipating plate 32 opposite to the driver IC 23. The thermal conductive medium 41 can also be interposed between the accommodating portion of the heat dissipating plate 32 and one side surface of the driver IC 23 opposite to the heat dissipating plate 32.

In more detail, the accommodating portion 50 is provided with an accommodating recess 36 formed on one side surface of a first portion 32a, and a projecting portion 38 is formed outwardly from the other side surface thereof corresponding to the accommodating recess 36. The width and height of the projection portion 38 are determined according to the width and depth of the accommodating recess 36.

Preferably, the driver IC 23 can be partly accommodated in the accommodating recess 36 at a predetermined height thereof based on the surface of FPC 21.

The thermal conduction medium 41 should be in a liquid or gel state at least at the operating temperature of the PDP 12, and a silicone oil or a thermal grease with a coefficient of thermal conductivity above 1.0 W/mK can be used.

Such a thermal conduction medium 41 not only serves to transfer the heat generated by the driver IC 23 to the heat dissipating plate 32, but also serves to fix the driver IC 23 in place, because the thermal conduction medium 41 is accommodated in the accommodating recess 36 and the thermal conduction medium 41 remains in a gel state around the driver IC partly 23 accommodated in the accommodating recess 36.

Since the driver IC 23 is fitted to fully contact the thermal conduction medium 41, it doesn't need a compression of the heat dissipating plate 32 against the driver IC 23 to be fixed in order to transfer the heat. Also, even if an external impact is applied to the chassis base 16 or if it is bent, since the driver IC 23 is accommodated in the recess 36 and is fitted to the thermal conduction medium 41 in a gel state, and since a gap is formed between the FPC 21 and the heat dissipating plate 32, the driver IC 23 is protected from damage.

Since the driver IC 23 is partly accommodating in the recess 36 and the heat dissipating plate 32 is fitted to the chassis base 16 by the fastening member, a predetermined gap is formed between the FPC 21 and the heat dissipating plate 32. As a result, since the thermal conduction medium 41 absorbs the direct impact between the FPC 21 and the heat dissipating plate 32 and since the external impact applied to the heat dissipating plate 32 is mitigated, damage, such a fracture of the FPC 21 or the like, is effectively prevented.

In accordance with the present invention, the thermal conduction medium 41 transfers the heat generated by the driver IC 23 to the heat dissipating plate 32. Since the thermal conduction medium 41 is accommodated in the recess 36 around the edges of the driver IC 23 as well as at a top surface thereof, both sides of the accommodating recess 36 facing the thermal conduction medium 41 also act as heat dissipating portions. As a result, the contact area for heat dissipation is increased when the heat dissipating plate 32 is close contact with the thermal conduction medium 41. Accordingly the coefficient of thermal conductivity of the thermal conduction medium 41 against the driver IC 23 is enhanced, thereby reducing the a temperature rise of the driver IC 23. Also, since the dissipating plate 32 is provided with the projection portion 38 on one face thereof, corresponding to the recess 36, the heat dissipating plate 32 can has a larger heat dissipating area to enhance its thermal dissipating efficiency.

Hereafter, in explaining the second through the ninth embodiments of the present invention, the same constitution elements as in the constitution elements of the first embodiment are used with the same reference numbers, and a detailed description thereof has been omitted for the sake of brevity.

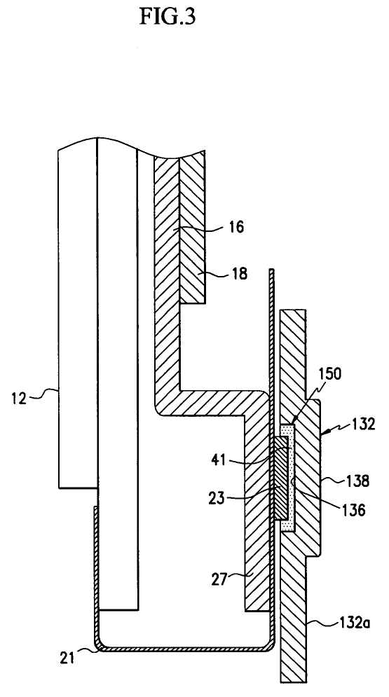

FIG. 3 is a cross-sectional view of a heat dissipating structure for a driver IC according to the second embodiment of the present invention.

With reference to FIG. 3, unlike the first embodiment, a heat dissipating plate 132 is provided with only a first portion 132a opposite to the driver IC 23. An accommodating portion 150 is provided with an accommodating recess 136 formed on the one side surface of the first portion 132a, and a projecting portion 138 formed outwardly from the other side surface thereof and corresponding to the accommodating recess 136. The width and height of the projection portion 138 is determined according to the width and depth of the accommodating recess 136.

As a result, since the heat dissipating plate 132 according to the second embodiment excludes the second portion 32b of FIG. 2, the total size of the plasma display apparatus and the material used for forming the heat dissipating plate are reduced, thereby resulting in a more compact and simplified plasma display apparatus.

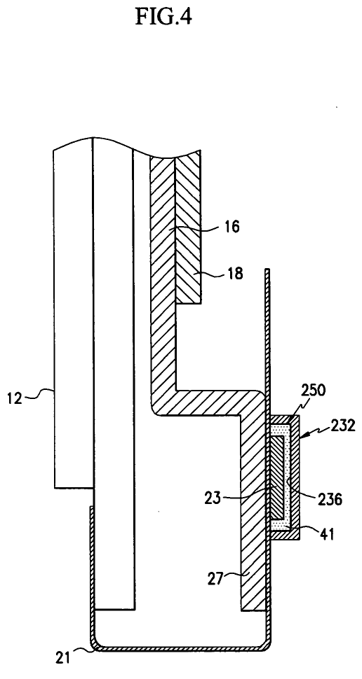

FIG. 4 is a cross-sectional view of a heat dissipating structure for a driver IC according to the third embodiment of the present invention.

With reference to FIG. 4, an accommodating recess 250 of a heat dissipating plate 232 has a “ [symbol] ”-shaped cross-section with an interior accommodating portion 236, and the heat dissipating plate 232 thereof is recessed and is fitted to the chassis base 16 so that it accommodates the thermal conductive medium 41 and the entire driver IC 23. Accordingly, the heat generated by the driver IC is effectively transferred to the heat dissipating plate 232 through the thermal conductive medium 41.

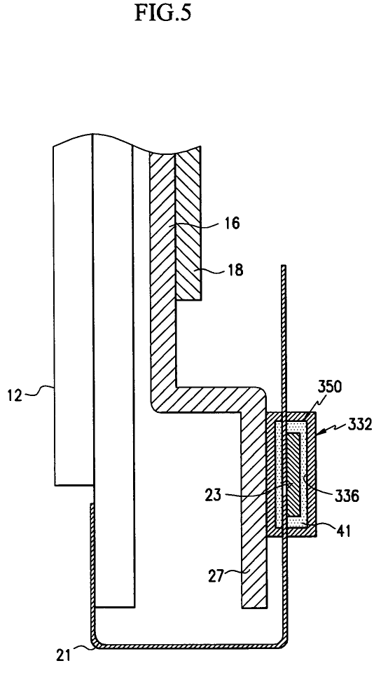

FIG. 5 is a cross-sectional view of a heat dissipating structure for a driver IC 23 according to the forth embodiment of the present invention.

With reference to FIG. 5, a heat dissipating plate 332 is constructed such that it is provided with an accommodating portion 350 having a cavity 336 on the interior thereof so as to surround the entire driver IC 23 and at least one portion of the FPC 21. The cavity 336 contains the thermal conduction medium 41. The FPC 21 penetrates into the accommodating portion 350. As a result, since the accommodating portion 350 and the thermal conduction medium 41 surrounds the entire driver IC 23, the coefficient of thermal conductivity of the thermal conduction medium 41 against the driver IC 23 is enhanced so that the heat generated by the driver IC 23 is effectively transferred to the heat dissipating plate 332 though the thermal conduction medium 41 and is dissipated into the air.

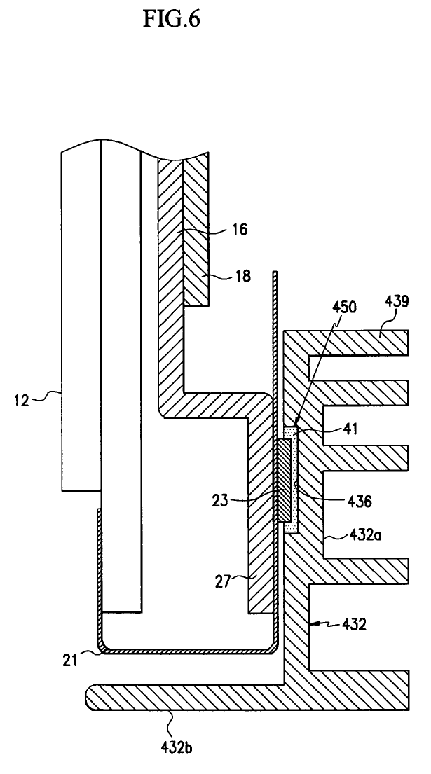

FIG. 6 is a cross-sectional view of a heat dissipating structure for a driver IC according to the fifth embodiment of the present invention.

With reference to FIG. 6, a heat dissipating plate 432 is constructed such that it is provided with a first portion 432a opposite to the driver IC 23 and a second portion 432b which extends from one distal end of the first portion 432a toward the peripheral edge of the PDP 12. The heat dissipating plate 432 has a heat sink structure with a plurality of a heat dissipating fins 439 arranged along the first portion 432a.

The thermal conduction medium 41 is arranged in an accommodating recess 436 of an accommodating portion 450 formed on the one side surface of the heat dissipating plate 432. As a result, the heat transferred to the heat dissipating plate 432 through the thermal conduction medium 41 is capable of additionally dissipating heat through the heat dissipating fins 439 projecting from the first portion 432a other side surface of the heat dissipating plate 432 to enhance the temperature dropping heat dissipating effect.

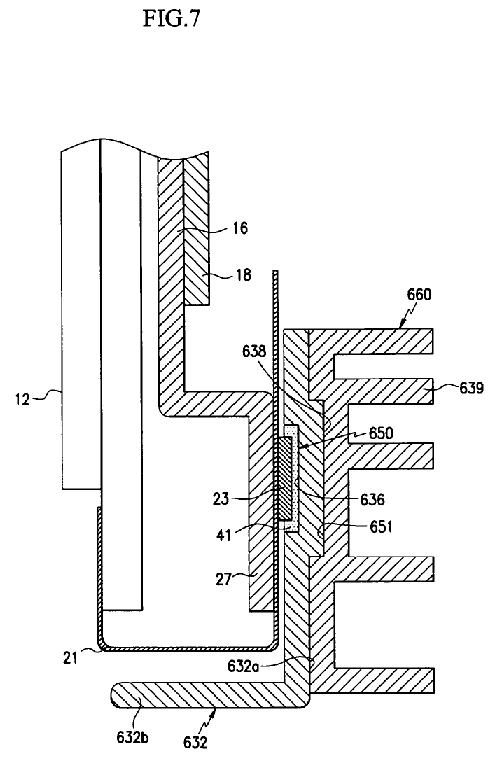

FIG. 7 is a cross-sectional view of a heat dissipating structure for a driver IC according to the sixth embodiment of the present invention.

With reference to FIG. 7, a heat dissipating plate 632 has first portion 632a opposite to the driver IC 23, and a second portion 632b extending from one distal end of the first portion 632a toward the peripheral edge of the PDP 12. The heat dissipating plate 632 is affixed to a heat sink 660 having a plurality of a heat dissipating fins 639.

An accommodating portion 650 for containing the driver IC 23 and the thermal conduction medium 41 has an accommodating recess 636 formed on the one side surface of the first portion 632a and a projecting portion 638 formed outwardly from the other side surface thereof and corresponding to the accommodating recess 636. The heat sink 660 has a registering coupling recess 651 arranged to couple with the projection portion 638 by having a shape corresponding thereto. As a result, since the contacting area where the heat dissipating plate 632 contacts with the heat sink 660 is increased, the heat generated by the driver IC 23 is more easily dissipated into the air through the heat sink 660.

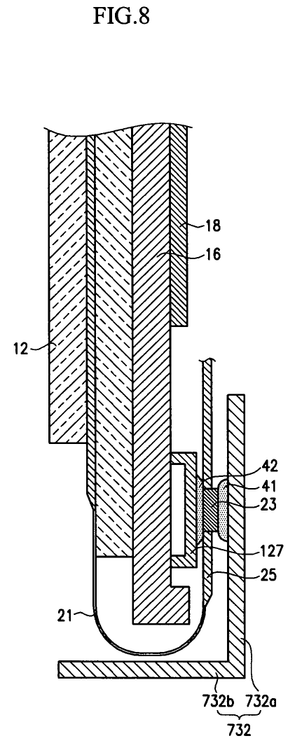

As discussed above, although the first through the sixth embodiments have a structure in which the TCP 25 is positioned on the extending portion 27 of the chassis base 16 (see FIGS. 2-7), the eighth through the tenth embodiments have a structure in which the TCP 25 is positioned on a thermally conductive solid member 127 projected from the chassis base 16, (see FIGS. 8-10).

FIG. 8 is a cross-sectional view of a heat dissipating structure for a driver IC according to the seventh embodiment of the present invention.

With reference to FIG. 8, a heat dissipating plate 732 has a first portion 732a opposite the driver IC 23, and a second portion 732b extending from one distal end of the first portion toward the peripheral edge of the PDP 12. The thermal conduction medium 41 is defined for convenience as a first thermal conduction medium 41, which is interposed between the driver IC 23 and the first portion 732a of the heat dissipating plate 732. A second thermal conduction medium 42 in a liquid or gel state is further interposed between the driver IC 23 and the high thermally conductive solid member 127.

In more detail, the thermal conduction medium 41 should be in a liquid or gel state at least at the operation temperature of the PDP 12, and can be a silicone oil or thermal grease. Such a thermal conduction medium 41 has a coefficient of thermal conductivity of more than 1.0 W/mK so as to not flow into the periphery of the circuit elements when the apparatus stands upright. Also, it is preferable that the first thermal conduction medium 41 has a thickness of 0.2 mm between the first portion 732a and the driver IC 23.

A fastening member (not shown) makes the heat dissipating plate 732 compress so as to contact the driver IC 23 with a predetermined pressure determined by the fastening force. With the above heat dissipating structure, the heat generated by the driver IC 23 is transferred through the first thermal conduction medium 41 to the heat dissipating plate 732 and is continuously dissipated into the air.

In addition, the second thermal conduction medium 42 has the same characteristics as that of the first conduction medium 41. Accordingly, the heat generated at the driver IC 23 is transferred through the second thermal conduction medium 42 to the high thermally conductive solid member 127. Then, the heat transferred to the high thermally conductive solid member 127 is conducted to the chassis base 16 and is continuously dissipated into the air.

In the plasma display apparatus according to the embodiment discussed above, the heat dissipating plate 732 is fitted to the high thermally conductive solid member 127 while compressing the driver IC 23 with a predetermined pressure. Then, the driver IC 23 is brought into close contact with the high thermally conductive solid member 127. Since the first thermal conductive medium 41 is interposed between the heat dissipating plate 732 and the driver IC 23, the first thermal medium 41 is in close contacted against the heat dissipating plate 732 and the driver IC 23. That is to say, an air layer is not formed on the boundary surface between the first thermal conduction medium 41 and the heat dissipating plate 732 and or between the first thermal conduction medium 41 and the driver IC 23.

In a comparative embodiment, a thermal conduction medium composed of sheet-type silicone was disposed between the heat dissipating plate 732 and the driver IC 23. When the heat dissipating characteristic of the comparative embodiment was compared to that of the present embodiment, a temperature difference between the heat transferred to the heat dissipating plate 732 and that generated by the driver IC was found. The temperature of the driver IC 23 applying the present invention was measured to be 2˜3° C. less than that of the driver IC 23 applying the comparative embodiment. This shows that the heat dissipating characteristic of the driver IC 23 according to the present embodiment is superior to that of the driver IC 23 according to the comparative embodiment.

In addition, since the second thermal conduction medium 42 disposed between the driver IC 23 and the high thermally conductive solid member 127 is formed of a liquid or gel as is the first thermal conductive medium, the second thermal conductive medium closely contacts the driver IC 23 and the high thermally conductive solid member 127. That is to say, an air layer is not formed on the boundary surface between the second thermal conduction medium 42 and the high thermally conductive solid member 127 or between the second thermal conduction medium 42 and the driver IC 23.

Therefore, the contact area between the heat dissipating plate 732 and the driver IC 23 is increased, thereby enhancing the coefficient of thermal conductivity from the driver IC 23 to the heat dissipating plate 732. Also, the contact area between the driver IC 23 and the high thermally conductive solid member 127 is increased, thereby enhancing the coefficient of thermal conductivity from the driver IC 23 to the high thermally conductive solid member 127.

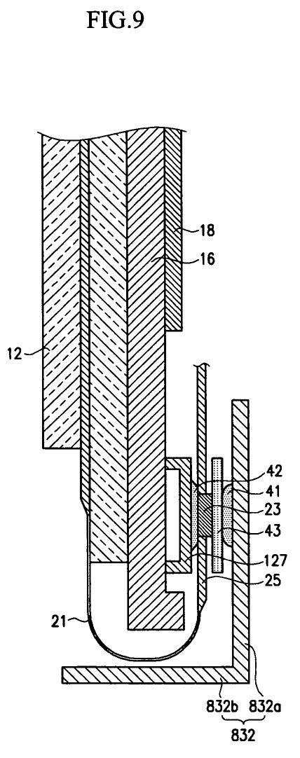

FIG. 9 is a cross-sectional view of a heat dissipating structure for a driver IC 23 according to the eighth embodiment of the present invention.

With reference to FIG. 9, a plasma display apparatus according to the eighth embodiment of the present invention has a structure in which a third thermal conduction medium 43 in the form of a sheet is interposed between the driver IC 23 and the first thermal conduction medium 41.

In this embodiment, the third thermal conduction medium 43 is disposed between the driver IC 23 and a first portion 832a of a heat dissipating plate 832, and the first thermal conduction medium 41 is disposed between the first portion 832a of the heat dissipating plate 832 and the thermal conduction medium 41. The heat dissipating plate 832 can also have a second portion 832b extending from one distal end of the first portion 832a toward the peripheral edge of the PDP 12 and intersecting with the first portion 832a so as to support the second portion 832b.

The third thermal conduction medium 43 can be formed of a silicone sheet affixed to one side of the driver IC 23 opposite the heat dissipating plate 832.

In this embodiment, since the first thermal conduction medium 41 disposed between the third thermal conduction medium 43 and the heat dissipating plate 832 is a liquid or gel, the first thermal conductive medium 41 is capable of more closely contacting the third thermal conduction medium 43 and the heat dissipating plate 832. That is to say, an air layer is not be formed on the boundary surface between the first thermal conduction medium 41 and the heat dissipating plate 832 or between the first and third thermal conduction medium 41 and 43.

Therefore, the contact area where the third thermal conduction medium 43 is in close contact with the first thermal conduction medium 41 is increased, thereby enhancing the coefficient of thermal conductivity from the driver IC 23 to the heat dissipating plate 832. Also, the contact area between the driver IC 23 and the high thermally conductive solid member 127 is increased, thereby enhancing the coefficient of thermal conductivity from the driver IC 23 to the high thermally conductive solid member 127.

That is to say, when the heat dissipating plate 832 is compressed toward the chassis base 16, the heat generated by the driver IC 23 is firstly transferred to the third thermal conduction medium 43 and then transferred to the first thermal conduction medium 41, thereby allowing the heat to be dissipated into the air by the heat dissipating plate 832. As a result, the temperature of the driver IC 23 is effectively reduced.

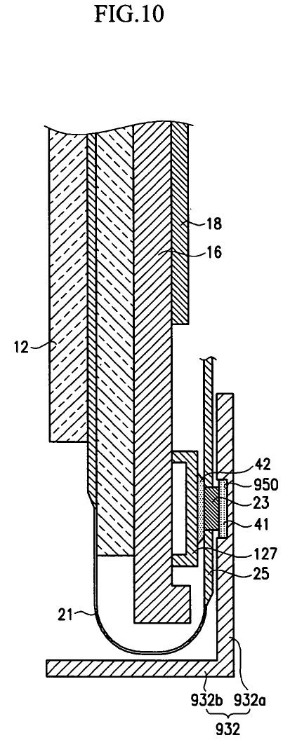

FIG. 10 is a cross-sectional view of a heat dissipating structure for a driver IC according to the ninth embodiment of the present invention.

With reference to FIG. 10, a plasma display apparatus according to the ninth embodiment of the present invention has an accommodating portion 950 for containing the first thermal conduction medium 41 on one side surface of a heat dissipating plate 932 opposite the driver IC 23.

The accommodating portion 950 is recessed into the heat dissipating plate 932 and is capable of accommodating the driver IC 23 and the first thermal conduction medium 41 of a liquid or gel in the recess.

As described above, with the plasma display apparatus according to this embodiment of the present invention, since the thermal conduction medium 41 contained in the recess of the accommodating recess portion 950 of the heat dissipating plate 932 surrounds the sides of the driver IC 23, the side surface of the recess can also act as a heat dissipating plate against the thermal conduction medium 41. Accordingly, the contact area where the heat dissipating plate 932 is in close contact with the thermal conduction medium 41 is increased, and the coefficient of thermal conductivity of the thermal conduction medium 41 to the driver IC is enhanced, thereby reducing the temperature increase of the driver IC 23.

Also, since the dissipating plate is provided with the projection portion on one face thereof corresponding to the recess, the heat dissipating plate can has a larger heat dissipating area to enhance the thermal dissipating efficiency of the driver IC 23.

Since the thermal conduction medium 41 is a liquid or gel at least at the operating temperature of the PDP 12, an air layer is not formed on the boundary surface between the thermal conduction medium 41 and the heat dissipating plate 932 or between the thermal conduction medium 41 and the driver IC 23, thereby enhancing the heat dissipating efficiency of the driver IC.

Also, since the thermal conduction medium 41 in a liquid or gel state can be jellied after injecting it into the accommodating portion 950, the thermal conduction medium 41 does not flow it into the periphery of the circuit element when the apparatus is upright, thereby protecting the circuit from contamination.

Although exemplary embodiments of the present invention have been described in detail above, it should be clearly understood that many variations and/or modifications of the basic inventive concept taught herein will be apparent to those skilled in the art and will still fall within the spirit and scope of the present invention, as recited in the appended claims.

1. A plasma display apparatus comprising:
a plasma display panel;
a chassis base arranged parallel to the plasma display panel;
a driver IC electrically connecting electrodes of the plasma display panel to a driving circuit, the driver IC adapted to supply voltage signals to the electrodes of the plasma display panel in accordance with signals from the driving circuit; and
a heat dissipating plate arranged adjacent to the driver IC and facing the chassis base to interpose the driver IC between the chassis base and a heat dissipating plate;
wherein the heat dissipating plate includes an accommodating portion adapted to accommodate the driver IC on a side surface thereof opposite to the driver IC.

2. The plasma display apparatus of claim 1, wherein the accommodating portion comprises a thermal conduction medium.

3. The plasma display apparatus of claim 1, wherein a thermal conduction medium is interposed between the driver IC and a side surface of the heat dissipating plate opposite thereto.

4. The plasma display apparatus of claim 2, wherein the thermal conduction medium is interposed between the accommodating portion of the heat dissipating plate and a side surface of the driver IC opposite thereto.

5. The plasma display apparatus of claim 2, wherein the accommodating portion of the thermal conduction medium is filled with a thermally conductive liquid or gel medium.

6. The plasma display apparatus of claim 2, wherein the thermal conduction medium is a silicone oil or a thermal grease.

7. The plasma display apparatus of claim 1, wherein the accommodating portion includes an accommodating recess concavely formed on a side surface of the heat dissipating plate.

8. The plasma display apparatus of claim 1, wherein the accommodating portion includes a projecting portion formed on another side surface thereof and corresponding to the accommodating recess.

9. The plasma display apparatus of claim 1, wherein a plurality of heat dissipating fins are arranged integrally on another side surface of the heat dissipating plate.

10. The plasma display apparatus of claim 1, wherein a heat sink is mounted on another side surface of the heat dissipating plate, the heat sink having a plurality of heat dissipating fins.

11. The plasma display apparatus of claim 1, wherein the heat dissipating plate comprises:
a first portion arranged in parallel with the chassis base so as to be opposed to the driver IC; and
a second portion extending integrally from one distal end of the first portion toward a peripheral edge of the plasma display panel.

12. The plasma display apparatus of claim 1, wherein the driver IC is electrically connected to electrodes of the plasma display panel via a Flexible Printed Circuit (FPC) and is wholly surrounded by the accommodating portion and wherein the accommodating portion is penetrated by the FPC passing therethrough.

13. The plasma display apparatus of claim 1, wherein the driver IC is packaged in a Tape Carrier Package (TCP).

14. A plasma display apparatus comprising:
a plasma display panel;
a chassis base having the plasma display panel on one side surface thereof and having a driving circuit arranged on another side surface thereof;
a driver IC electrically connecting electrodes of the plasma display panel to the driving circuit, the driver IC adapted to supply voltage signals to the electrodes of the plasma display panel in accordance with signals from the driving circuit;
a heat dissipating plate arranged adjacent to the driver IC and facing the chassis base to interpose the driver IC between the chassis base and the heat dissipating plate; and
a first thermal conduction medium arranged between the heat dissipating plate and the driver IC and adapted to transfer heat generated by the driver IC to the heat dissipating plate.

15. The plasma display apparatus of claim 14, wherein the first thermal conduction medium is a thermally conductive liquid or gel medium.

16. The plasma display apparatus of claim 14, wherein the first thermal conduction medium is silicone oil or a thermal grease.

17. The plasma display apparatus of claim 14, wherein the first thermal conduction medium has a coefficient of thermal conductivity of not less than 1.0 W/mK and a viscosity of not less than 100,000 cps.

18. The plasma display apparatus of claim 14, wherein a high thermally conductive solid member is arranged on a portion of the chassis base opposite the driver IC.

19. The plasma display apparatus of claim 18, further comprising a second thermal conduction medium disposed between the solid member and the driver IC and adapted to transfer heat generated by the driver IC to the high thermally conductive solid member.

20. The plasma display apparatus of claim 19, wherein the second thermal conduction medium is a thermally conductive liquid or gel medium.

21. The plasma display apparatus of claim 19, further comprising a third thermal conduction medium arranged between the first thermal conduction medium and the driver IC.

22. The plasma display apparatus of claim 21, wherein the second thermal conduction medium is a thermally conductive sheet.

23. The plasma display apparatus of claim 19, wherein the heat dissipating plate further comprises an accommodating portion adapted to accommodate the first thermal conduction medium on a side surface thereof opposite the driver IC.
